(19) United States
(12) Patent Application Publication
(10) Pub. No.: US 2025/0145226 A1
(43) Pub. Date: May 8, 2025

(54) CASTING CLIPS

(71) Applicant: Tesla, Inc., Austin, TX (US)

(72) Inventors: Rene Sanchez Nava, Lathrop, CA (US); Markus Boehm, Fremont, CA (US); Yongquan Yu, Kyle, TX (US)

(21) Appl. No.: 18/836,980

(22) PCT Filed: Feb. 6, 2023
(86) PCT No.: PCT/US2023/012391

§ 371 Date: Aug. 8, 2024

Related U.S. Application Data
(60) Provisional application No. 63/267,769, filed on Feb. 9, 2022.

(51) Int. Cl. B62D 27/06; B62D 29/00; F16B 5/06

(52) U.S. Cl. CPC B62D 27/06; B62D 29/004; F16B 5/0621

(57) ABSTRACT

A clip secures a component to a body part. The body part is made from a die-cast material and have a surface feature. The clip can include a first engagement feature configured to engage the component so as to secure the clip to the component and a second engagement feature configured to engage the surface feature of the body part. The clip remains engaged with the surface feature when the component is disengaged from the first engagement feature of the clip.

### CROSS-REFERENCE TO RELATED APPLICATIONS

This application claims the benefit of U.S. Provisional Application No. 63/267,769, filed Feb. 9, 2022, the entire disclosure of which is hereby incorporated by reference in its entirety.

### TECHNICAL FIELD

This application relates in general to clips and more specifically to clips for securing components (e.g., trim, lines, etc.) to a die-cast material or casting. The die-cast material or casting can form a body part which includes a surface feature configured to engage with the clip. The clip can releasably couple the component to the body part.

### BACKGROUND

Generally described, a variety of vehicles, such as electric vehicles, combustion engine vehicles, hybrid vehicles, etc., can be configured with die-cast body parts. Die-cast body parts can be formed on a large scale as a “mega casting” more efficiently than traditional methods of welding a multitude of stamped or extruded body details together to form the larger body part. The traditional manufacturing process requires a significant amount of post weld processing to add, for example, laser cut slots and machined holes. Thus, there is a need for a robust attachment system and method for subsequent attachment of components to large scale die-cast components that does not require costly and time consuming machining of slots and holes.

### SUMMARY

An aspect is directed to embodiments of a casting clip configured to engage with a surface feature of a die-cast body part or casting. For example, an aspect is directed to a clip for securing a component to a body part. The body part comprises a die-cast material and a surface feature. The clip includes a first engagement feature configured to engage the component so as to secure the clip to the component and a second engagement feature configured to engage the surface feature of the body part or casting. The clip remains engaged with the surface feature of the casting when the component is disengaged from the first engagement feature of the clip.

A variation of the aspect above is, wherein the component comprises a polymer.

A variation of the aspect above is, wherein the die-cast material is aluminum.

A variation of the aspect above is, wherein the body part is of a vehicle.

A variation of the aspect above is, wherein the clip is a cylinder type.

A variation of the aspect above is, wherein the clip is a rib type.

A variation of the aspect above is, wherein the clip is an inverted trim type.

A variation of the aspect above is, wherein the clip comprises an insert, an overmold, and a base.

A variation of the aspect above is, wherein the insert comprises steel.

A variation of the aspect above is, wherein the overmold comprises polypropylene with 20% glass fiber (PP-GF20).

A variation of the aspect above is, wherein the base comprises polyoxymethylene (POM).

A variation of the aspect above is, wherein the insert, the overmold, and the base stay engaged with the surface feature when the component is disengaged from the first engagement feature.

A variation of the aspect above is, wherein the clip is a rib type.

A variation of the aspect above is, wherein the clip comprises a component clip, a holder, and a clamp.

A variation of the aspect above is, wherein the component clip comprises steel.

A variation of the aspect above is, wherein the holder comprises polyoxymethylene (POM).

A variation of the aspect above is, wherein the clamp comprises polyoxymethylene (POM).

A variation of the aspect above is, wherein the component clip stays engaged with the surface feature when the holder and the clamp are removed together as a subassembly.

A variation of the aspect above is, wherein the clip is an inverted trim type.

A variation of the aspect above is, wherein the clip comprises metal.

A variation of the aspect above further comprises spurs or teeth.

A variation of the aspect above is, wherein the clip stays engaged with the surface feature when the component is disengaged from the first engagement feature.

A variation of the aspect above is, wherein the component comprises a housing sized and shaped to receive the clip.

An aspect is directed to a method of reusing a clip. The method comprises engaging the clip with a component part by applying an insertion force and engaging the component part and the clip as a subassembly to a surface feature with an installation force. A disassembly force between the clip and the surface feature is greater than a disassembly force between the component part and the clip.

A variation of the aspect above is, wherein the component part comprises a housing, and wherein the clip engages with the housing.

A variation of the aspect above further comprises removing the component part from the surface feature while the clip stays engaged with the surface feature.

A variation of the aspect above further comprises reattaching the component part to the clip while the clip is engaged to the surface feature.

A variation of the aspect above is, wherein the component part is a panel of a vehicle, and wherein the surface feature is on a body part of the vehicle.

A variation of the aspect above is, wherein the body part comprises a die-cast material.

An aspect is directed to a clip for securing a component to a body. The clip comprises a first engagement feature configured to engage the component so as to secure the clip to the component and a second engagement feature configured to engage the body, wherein a disassembly force between the clip and the component is less than a disassembly force between the clip and the body.

A variation of the aspect above is, wherein the first engagement structure comprises a size and shape of the clip.

A variation of the aspect above is, wherein the second engagement structure comprises one or more spurs.

A variation of the aspect above is, wherein the clip comprises metal.

A variation of the aspect above is, wherein the body comprises a die-cast material.

A variation of the aspect above is, wherein the component is a panel for a vehicle.

A variation of the aspect above is, wherein the body is a part of the vehicle.

### BRIEF DESCRIPTION OF THE DRAWINGS

The present inventions are described with reference to the accompanying drawings, in which like reference characters reference like elements, and wherein:

FIG. 1 is an exemplary illustration of a vehicle that includes one or more die-cast components or body parts forming a rear underbody and employing an attachment system for securing components to the rear underbody according to an embodiment.

FIG. 2 is similar to FIG. 1 except components of the vehicle are removed to expose the rear underbody.

FIG. 3 is view of the rear underbody showing a plurality of surface features for engaging with embodiments of a casting clip.

FIG. 4 is similar to FIG. 3 except the casting clips are shown engaged with the surface features of the casting.

FIG. 5 is a perspective view of a first embodiment of the casting clip.

FIG. 6 is an exploded view of the casting clip from FIG. 5.

FIGS. 7A and 7B are perspective views of an assembly process for the casting clip from FIG. 5.

FIG. 8 include views of a process for installing the clip from FIG. 5 to a surface feature of the rear underbody.

FIGS. 9A and 9B show a wheelhouse liner being locked to the casting clip of FIG. 8.

FIGS. 10A and 10B show the wheelhouse liner being unlocked and removed from the casting clip of FIG. 8.

FIG. 11 includes drawing views of the casting clip from FIG. 5.

FIG. 12 is a perspective view of a second embodiment of the casting clip

FIG. 13 is an exploded view of the clip from FIG. 12 showing a holder, a clamp, and a component clip.

FIG. 14 include views of a process for installing the casting clip from FIG. 12 on to a surface feature of a body part or casting.

FIGS. 15A and 15B are similar to FIG. 14 except the holder and the clamp are removed from the surface feature of the casting leaving the component clip engaged with the surface feature.

FIG. 16 includes drawing views of the casting clip from FIG. 12.

FIG. 17 includes drawing views of the clamp from FIG. 16.

FIG. 18 includes drawing views of the holder from FIG. 16.

FIG. 19 includes drawing views of the component clip from FIG. 16.

FIG. 20 includes views of a third embodiment of the casting clip.

FIG. 21 includes views of a surface feature configured to engage the casting clip of FIGS. 20 and 22.

FIG. 22 includes views of a fourth embodiment of the casting clip.

FIG. 23 includes views of a surface feature configured to engage the casting clip of FIGS. 20 and 22.

FIG. 24 shows a step 1 for inserting the casting clip of FIGS. 20 and 22 into a housing of a component part.

FIG. 25 shows a step 2 where the casting clip has been installed in the component part before the component part is assembled to the casting or body part.

FIG. 26 shows a step 3 where the housing is being aligned above the surface feature prior to lowering the component part onto the casting or body part.

FIG. 27 shows a step 4 after the component part has been removed from casting leaving the component clip installed on the surface feature.

### DETAILED DESCRIPTION

Generally described, one or more aspects of the present disclosure relate to clips and more specifically to clips for securing components to a casting made from die-cast material. The die-cast material can form a casting or body part which includes a surface feature configured to engage with the casting clip. The casting clip can releasably couple the component to the casting or body part. In certain embodiments, the casting clip eliminates the process of machining slots into casted body features, which saves cycle time in production. In certain embodiments, the casting clip is serviceable and reusable. In certain embodiments, the casting clip comprise one or more components.

In certain embodiments, the casting clip comprises a first engagement feature configured to engage a component so as to secure the clip to the component. In certain embodiments, the casting clip further comprises a second engagement feature configured to engage a surface feature of a body part or casting and remain engaged with the surface feature when the component is disengaged from the second engagement feature of the casting clip.

In certain embodiments, the casting clip can be used to attach polymer components to aluminum die-cast bodies. In certain embodiments, the vehicle structure requires less post-process machining operations. In certain embodiments, the casting clips are applicable to the dry side of the body as well as the wet side of body with an extra seal. The casting clips can be employed for exteriors and applicable automotive parts that need to be attached to the vehicle structure. Use of the certain embodiments of the clip can eliminate the need for machining features in casted body parts and provide serviceable and reusable, haptic feedback for installation and service.

Certain embodiments of the casting clip can eliminate processes for complicated manufacturing and installation as well as reduce associated part numbers and costs which increases manufacturing output of body vehicle structures. For example, use of existing clips require machined holes in the casting. The casting clip embodiments disclosed herein, can reduce or eliminate the machined holes. Certain embodiments of the clip reduce tolerance stack-up errors and increase part alignment accuracy by employing modeled features as compared to machined features. In certain embodiments, the casting clips are secured to surface features (e.g., ribs and posts) of the casting or body part.

An embodiment can be a cylinder type casting clip. In certain embodiments, the casting clip has three components. In certain embodiments, the components include an insert, an overmold, and a base. In certain embodiments, the insert is made from a high performance spring steel. In certain embodiments, the overmold is made from a polymer (e.g., synthetic polymers including polypropylene with 20% glass fiber (PP-GF20)). In certain embodiments, the base is made from a polymer (e.g., polyoxymethylene (POM)). In certain embodiments, the wheelhouse liner can be removed from the cylinder type casting clip by pinching together the snap fits of the casting clip. In certain embodiments, the cylinder type casting clip engage an outer surface of a cylindrical die-cast post. In certain embodiments, the installation of the cylinder type casting clip is confirmed with an audible sound such as a click. In certain embodiments, the cylinder type casting clip can be employed depending on if a high pull force extracts the part out of position. In certain embodiments, the cylinder type casting clip is employed as a high tolerance joining clip for hard and soft trim component parts which may need a relatively high retention force.

Another embodiment can be a rib type casting clip. In certain embodiments, the casting clip has three components. In certain embodiments, the components include a steel clip, a holder, and a clamp. In certain embodiments, the clip is made from a high performance spring steel. In certain embodiments, the holder is made from POM In certain embodiments, the clamp is made from POM. In certain embodiments, the rib type casting clip can be removed from the casting or body part by pulling the holder to separate the holder and the clamp from the component clip for reusability. In certain embodiments, the rib type casting clip engages an outer surface of a die-cast rib on the casting or body part. In certain embodiments, the installation of the rib type casting clip is confirmed with an audible sound such as a click. In certain embodiments, the rib type casting clip can be employed depending on if a high pull force extracts the part out of position. In certain embodiments, the rib type casting clip is employed as a cable routing clip for alignment of certain HVAC tubes as needed.

Another embodiment of the clip can include an inverted trim casting clip having a single metal component with teeth or spurs. In certain embodiments, the inverted trim casting clip is pre-installed to a trim panel (e.g., component part) and stays on the casting after initial trim installation. For example, in certain embodiments, the inverted trim casting clip is installed at the supplier level directly to the trim panel which removes the installation process for associates at general assembly line. This can eliminate having to attach extra fasteners to the casting or body part. In certain embodiments, upon removal of the component part, the clip will remain on the casting or body part, which allows products to be removed without damage to the clip (i.e., the clip retains its functionality). In certain embodiments, the inverted trim casting clip can be employed depending on if a high pull force extracts the part out of position. In certain embodiments, the inverted trim casting clip is employed when the mating feature on the polymer trim component is designed as a floating datum to absorb tolerances.

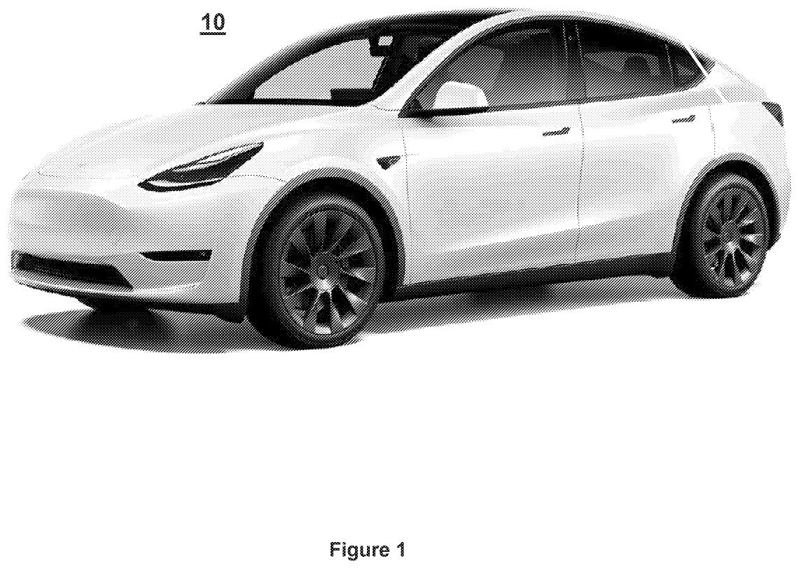

FIG. 1 is an exemplary illustration of a vehicle 10 that includes one or more die-cast components. In certain embodiments, the die-cast components can form a rear underbody 12 of the vehicle 10. In certain embodiments, the vehicle 10 employs an attachment system for securing components to the rear underbody 12. Of course, the attachment system disclosed herein is not limited to use with the rear underbody 12 but instead can be employed with any die-cast component. Further, while the description is provided in the context of an automobile, the attachment system is not limited to use in the automotive industry and can instead be used in any industry.

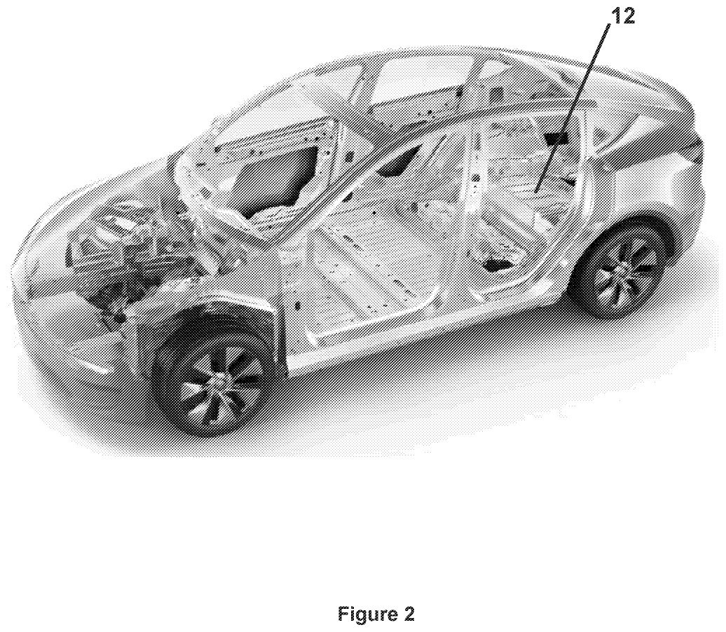

FIG. 2 is similar to FIG. 1 except components of the vehicle 10 are removed to expose the rear underbody 12 An exemplary vehicle 10 can include multiple large die-cast aluminum rear body pieces (e.g., inner wheelhouse, frame rails, and strut towers). In certain embodiments, the rear body pieces can be joined together with a bonded/bolted bracket to form the rear underbody 12. In certain embodiments, the large diecast pieces or “mega casting” are formed with a high-pressure press and can replace about 50 conventional stampings, extrusions, and castings for the same part.

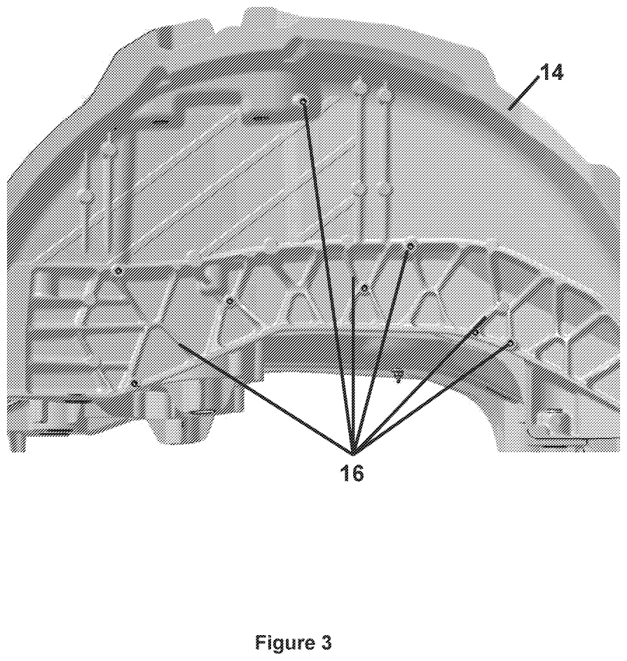

FIG. 3 is view of the rear underbody 12 showing a plurality of surface features 16 for engaging one or more clips 18, 20. Conventionally, the surfaces features (e.g., holes) would require machining which takes lots of cycle time. In contrast, as disclosed herein, the attachment system does not require machined holes and can eliminate most machined holes which saves cycle time in production.

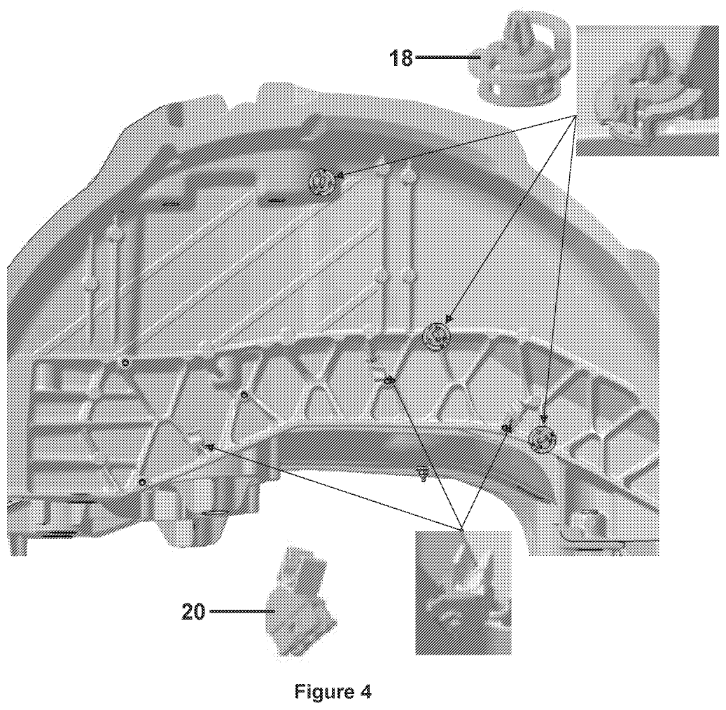

FIG. 4 is similar to FIG. 3 except embodiments of the clips 18, 20 are shown engaged with the surface features 16. For example, the clip 18 can be a cylinder type casting clip. In certain embodiments, the cylinder type casting clip 18 can be removed by pinching the snap fits of the casting clip 18. In certain embodiments, the surface feature 16 for engaging with the cylinder type casting clip 18 is in the form of an outer surface of a cylindrical die-cast post.

For example, the clip 20 can be a rib type casting clip. In certain embodiments, the surface feature 16 for the rib type casting clip 20 is in the form of an outer surface of a rib.

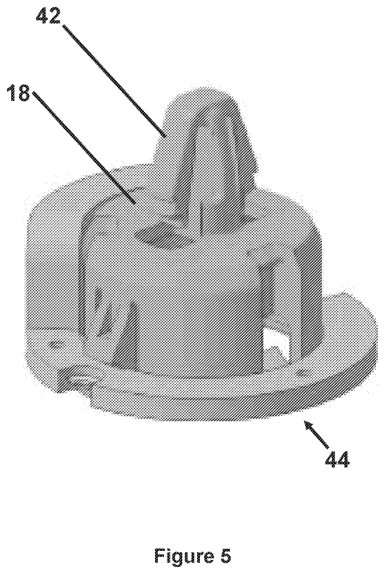

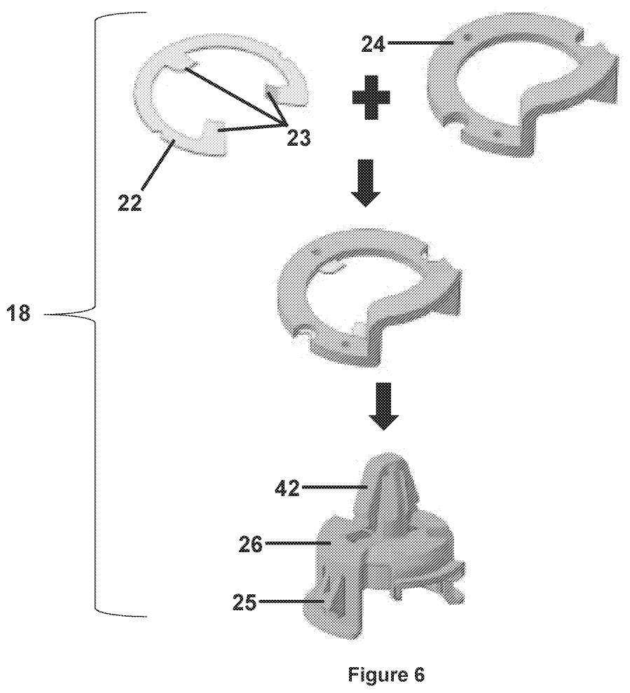

FIG. 5 is a perspective view of a first embodiment of the casting clip 18. FIG. 6 is an exploded view of the casting clip 18 from FIG. 5. In certain embodiments, the casting clip 18 has three components. Of course, the casting clip 18 can have fewer or more components than three. In certain embodiments, the components include an insert 22, an overmold 24, and a base 26. In certain embodiments, the insert 22 is made from a high performance spring steel. In certain embodiments, the overmold 24 is made from a polymer (e.g., synthetic polymers including polypropylene with 20% glass fiber (PP-GF20)). In certain embodiments, the base 26 is made from a polymer (e.g., polyoxymethylene (POM)). Of course the listed materials are only exemplary and can instead be any other material.

In certain embodiments, the casting clip 18 can be removed by pinching snap fits 25 of the casting clip 18. In certain embodiments, the casting clip 18 catches an outer surface of a cylindrical die-cast post 16. In certain embodiments, the installation of the casting clip 18 is confirmed with the audible sound of a click. In certain embodiments, the casting clip 18 can be employed depending on if a high pull force extracts the part out of position. In certain embodiments, the casting clip 18 is employed as a high tolerance joining clip for hard and soft trims which may need a relatively high retention force.

In certain embodiments, the casting clip 18 comprises a first engagement feature 42 (e.g., snap fit) configured to engage a component part (e.g., wheelhouse liner 28) so as to secure the casting clip 18 to the component part. In certain embodiments, the casting clip 18 further comprises a second engagement feature 44 configured to engage the surface feature 16 of the casting or body part and remain engaged with the surface feature 16 when the component part is disengaged from the first engagement feature 42 of the casting clip 18.

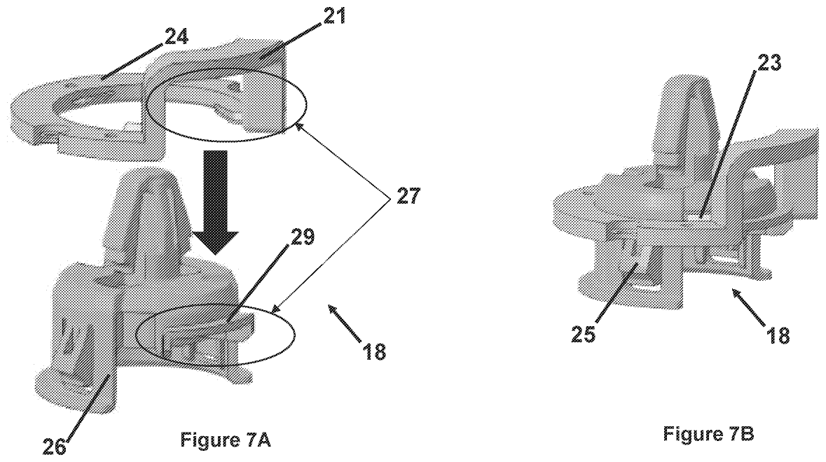

FIGS. 7A and 7B are perspective views of an assembly process for the casting clip 18 from FIG. 5. In certain embodiments, the overmold 24 is installed to the base 26. In certain embodiments, a poke-yoke feature 27 can help to orient the overmold 24 on the base 26. For example, in certain embodiments, the poke-yoke feature 27 comprises a lip 29 on the base 26 and a bar 21 of the overmold 24. In certain embodiments, fingers 23 of the insert 22 pass a hard point of the base 26 and are held on a top side of the base 26 once assembled. In certain embodiments, the plastic snap fit 25 constrains the overmold 24 from dislodging from the base 26. The casting clip 18 as illustrated in FIG. 7B is assembled and ready for installation on the surface feature 16 of the casting or body part 14.

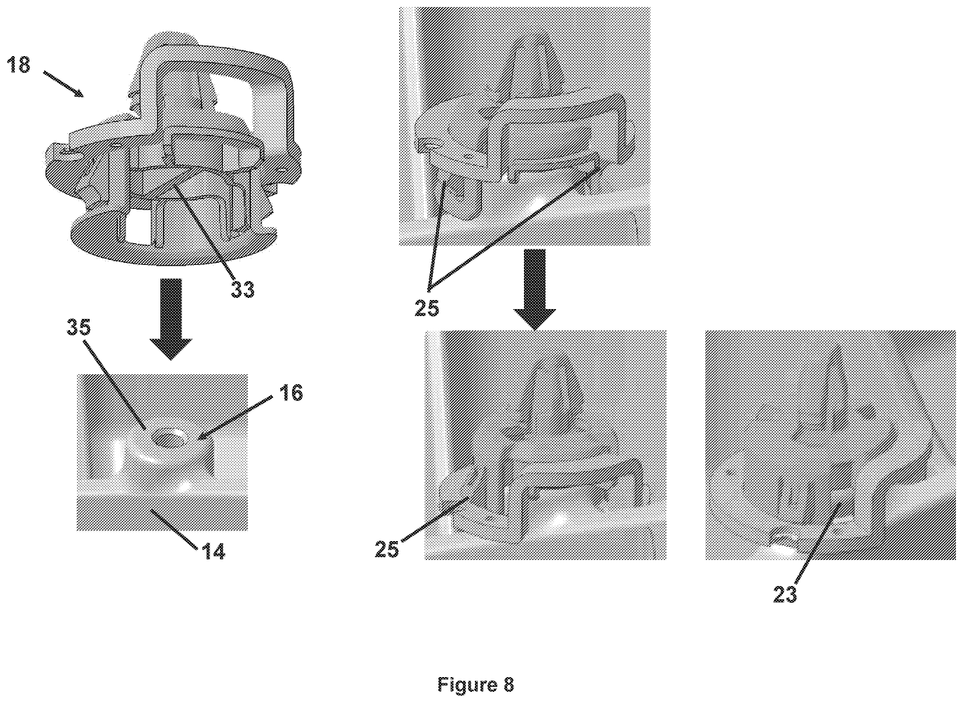

FIG. 8 include views of a process for installing the casting clip 18 from FIG. 5 to a surface feature 16 (e.g., post) of the casting or body part 14. In certain embodiments, a contact surface 33 of the casting clip 18 is landed on a top surface 35 of the surface feature 16 (e.g., post). In certain embodiments, the overmold 24 is pressed down to pass the snap fits 25 on the base 26 until locked. In certain embodiments, the fingers 23 of the insert 22 bite into the post of the surface feature 16 when the overmold 24 is locked on the base 26.

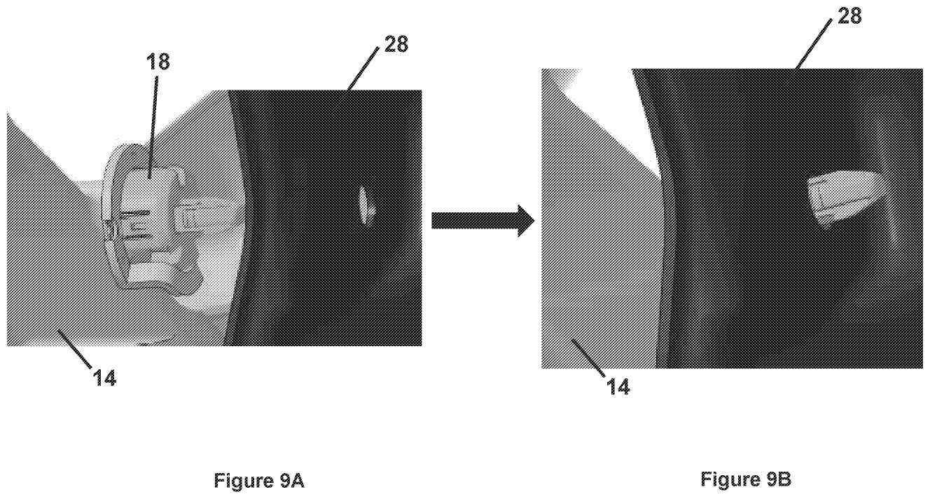

FIGS. 9A and 9B show a component part (e.g., wheelhouse liner 28) being locked to the casting clip 18 of FIG. 8. In FIG. 9A, the wheelhouse liner 28 is pushed onto the casting clip 18. In FIG. 9B, the wheelhouse liner 28 is locked in place on the casting clip 18.

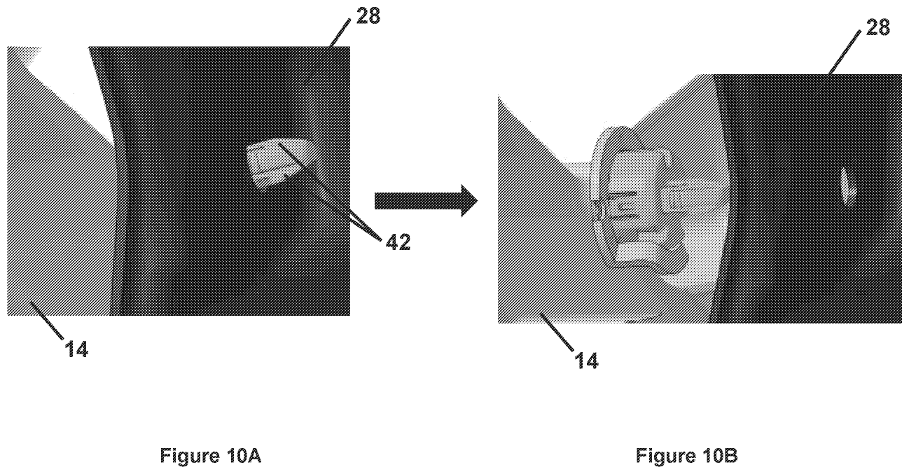

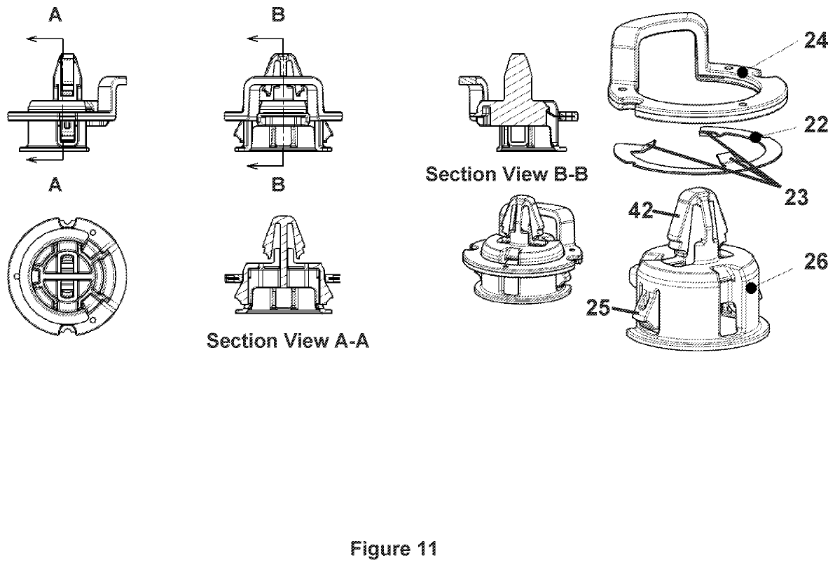

FIGS. 10A and 10B show the wheelhouse liner 28 being unlocked from the clip 18 of FIG. 8. In FIG. 10A, the first engagement feature 42 (e.g., snap fits) of the clip 18 are pinched together. In FIG. 10B, the wheelhouse liner 28 is removed from the casting clip 18 by being slid past the first engagement feature 42 (e.g., snap fits). FIG. 11 includes drawing views of the casting clip 18 of FIG. 5.

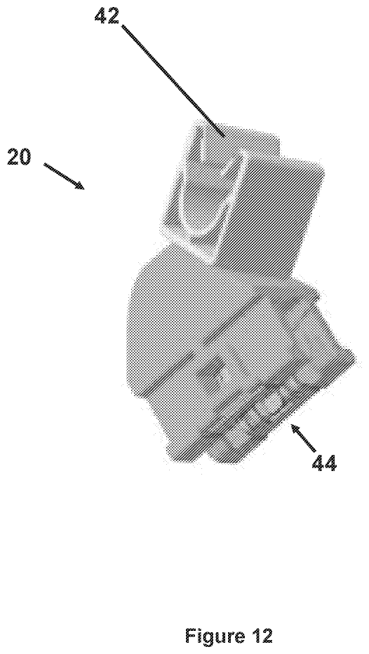

FIG. 12 is a perspective view of a second embodiment of the casting clip 20. In certain embodiments, the clip 20 comprises the first engagement feature 42 (e.g., snap fit) configured to engage a component part (e.g., line) so as to secure the casting clip 20 to the component part. In certain embodiments, the casting clip 20 further comprises the second engagement feature 44 configured to engage the surface feature 16 of the casting or body part 14 and remain engaged with the surface feature 16.

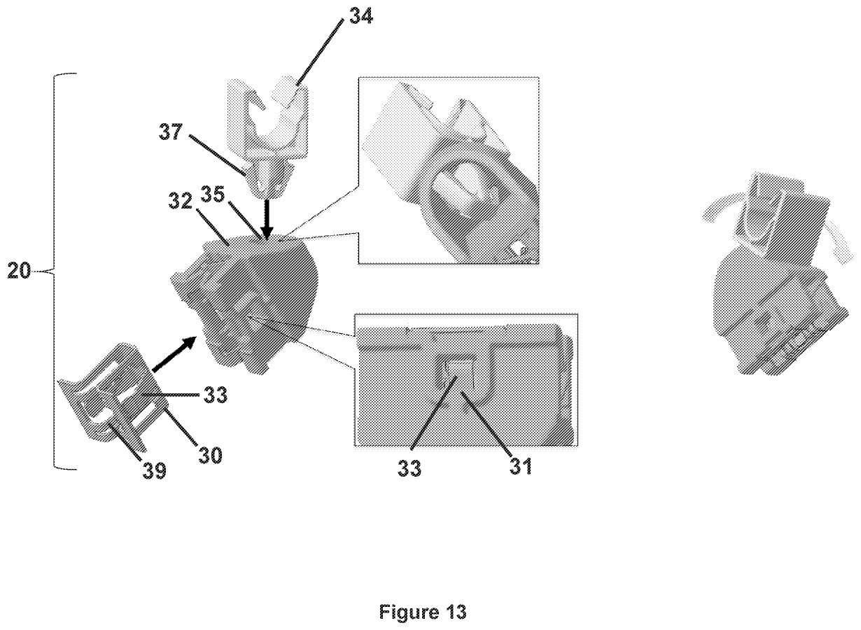

FIG. 13 is an exploded view of the casting clip 20 from FIG. 12. In certain embodiments, the casting clip 20 has three components. Of course, the casting clip 20 can have fewer or more components than three. In certain embodiments, the components include a component clip 30, a holder 32, and a clamp 34. In certain embodiments, the component clip 30 is made from a high performance spring steel. In certain embodiments, the holder 32 is made from POM. In certain embodiments, the clamp 34 is made from POM. Of course the listed materials are only exemplary and can instead be any other material.

In certain embodiments, the rib type casting clip 20 can be removed by pulling the holder 32 to separate it from the component clip 30 for reusability. In certain embodiments, the rib type casting clip 20 catches an outer surface of a surface feature 16 (e.g., a die-cast rib) of the casting or body part 14. In certain embodiments, the installation of the rib type casting clip 20 is confirmed with an audible sound such as a click. In certain embodiments, the rib type casting clip 20 can be employed depending on if a high pull force extracts the part out of position. In certain embodiments, the rib type casting clip 20 is employed as cable routing clips for alignment of certain tubes (e.g., HVAC, brake, etc.) as needed.

In certain embodiments, snap fits 37 of the clamp 34 are held by a hole 35 in the holder 32. In certain embodiments, the connection between the clamp 34 and the holder 32 is not serviceable. In certain embodiments, the snap fits 33 of the component clip 30 are secured by windows 31 in the holder 32. In certain embodiments, the connection between the component clip 30 and the holder 32 is serviceable. In certain embodiments, the clamp 34 can be rotated to facilitate routing of the line (e.g., brake line).

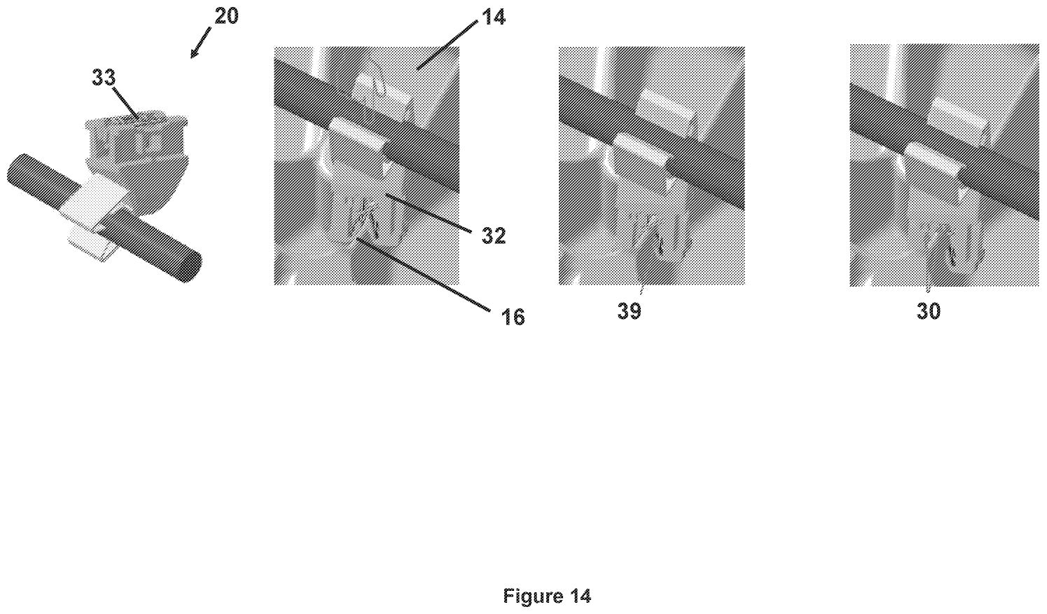

FIG. 14 include views of a process moving from left to right for installing the casting clip 20 from FIG. 12 to a surface feature 16 of a casting or body part 14. In certain embodiments, the casting clip 20 comes preassembled including the component clip 30, the holder 32, and the clamp 34. In certain embodiments, the casting clip 20 is preassembled to the line or pipe (e.g., HVAC, brake, etc.). In certain embodiments, the component clip 30 is pressed on the surface feature 14 (e.g., rib). In certain embodiments, the lead-in and the snap fits 33 guide the surface feature 14 into the casting clip 20. In certain embodiments, spurs 39 of the component clip 30 bite into the surface feature 14. In certain embodiments, the surface feature 14 (e.g., rib) pushes a component clip 30 feature to pass a hard point on the holder 32 to create a clicking sound. In certain embodiments, a stopper on the holder 32 will then stop further engagement with the surface feature 14.

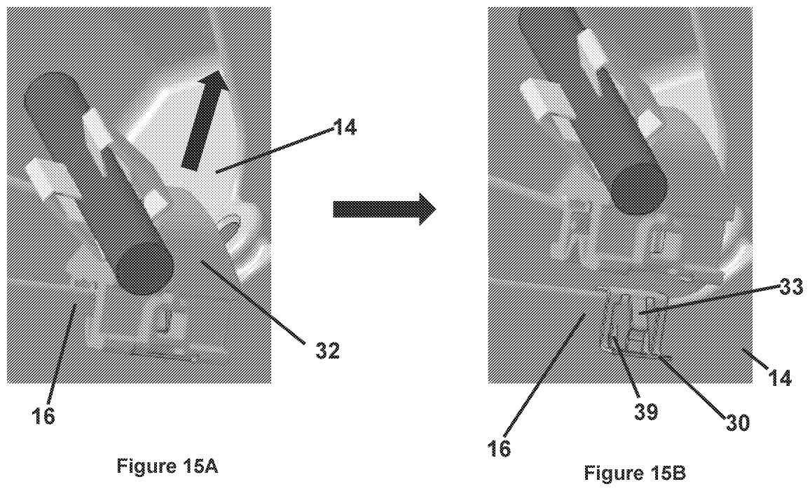

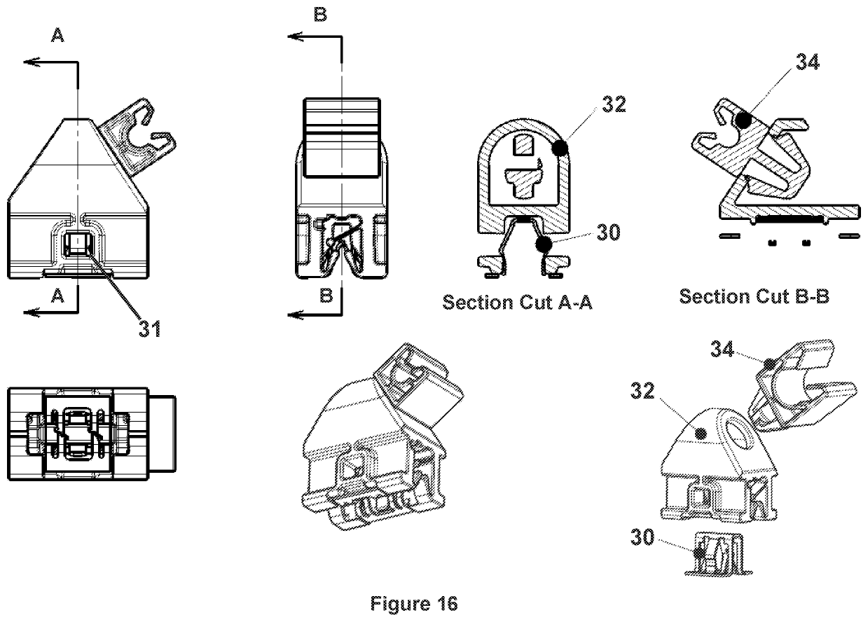

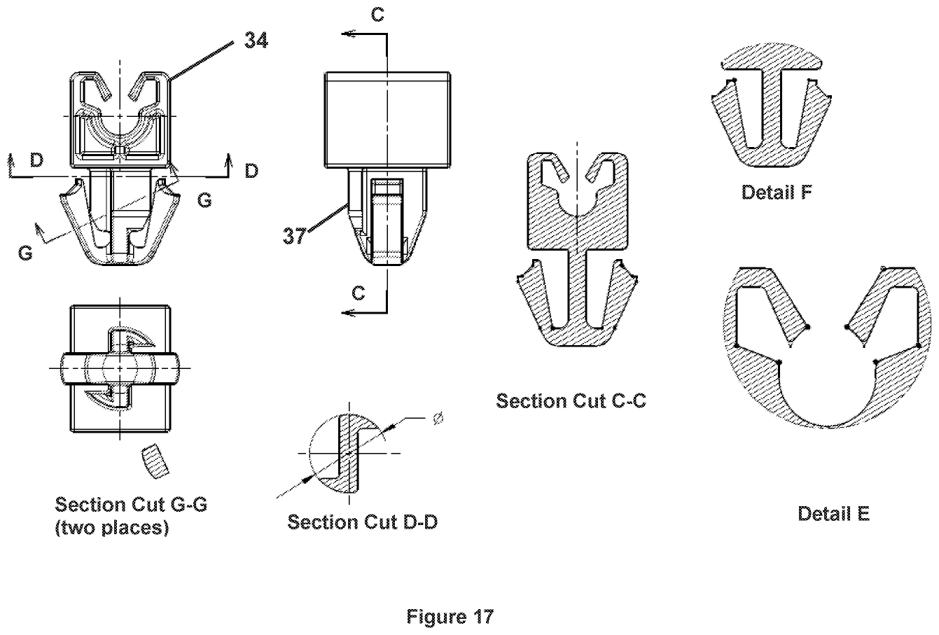

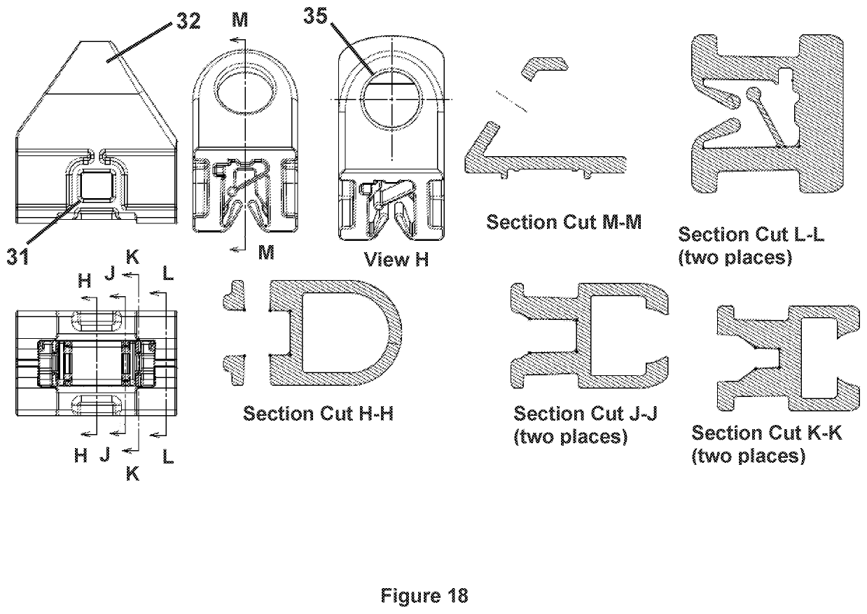

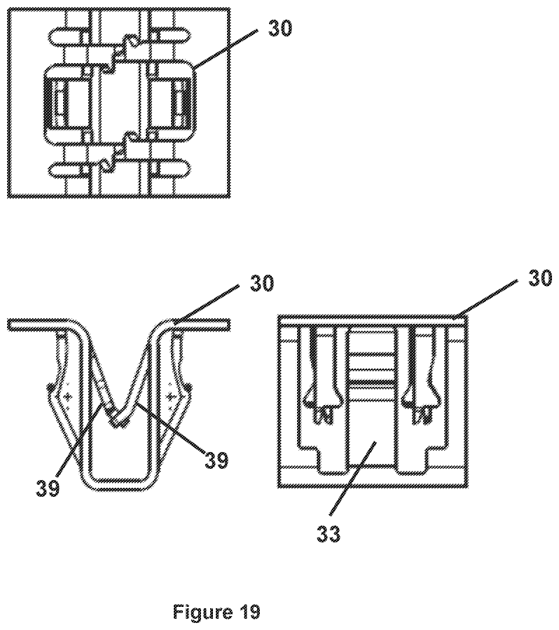

FIGS. 15A and 15B are similar to FIG. 14 except the holder 32 and the clamp 34 are removed from the surface feature 14 leaving the component clip 30. For example, as is illustrated in FIG. 15A, the user pulls the holder 32 in a direction away from the surface feature 14 to remove the holder 32 and the clamp 34 as a subassembly. Once removed, the component clip 30 remains on the surface feature 14 and is available for the same or another holder 32 and clamp 34 subassembly to be attached to the component clip 30. FIG. 16 includes drawing views of the casting clip 20 from FIG. 12. FIG. 17 includes drawing views of the clamp 34 from FIG. 16. FIG. 18 includes drawing views of the holder 32 from FIG. 16. FIG. 19 includes drawing views of the component clip 30 detail from FIG. 16.

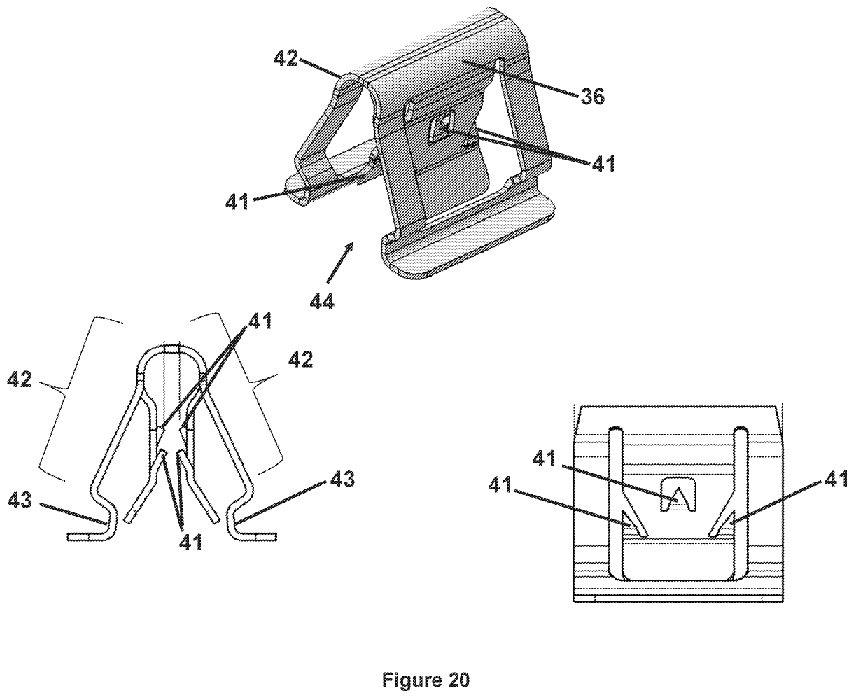

FIG. 20 includes views of a third embodiment of the casting clip 36 in the form of an inverted trim casting clip 36. In certain embodiments, the inverted trim casting clip 36 is pre-installed to a housing 38 (e.g., trim panel) and stays on the body part or casting 14 after initial trim installation. For example, in certain embodiments, the casting clip 36 is installed at the supplier level directly to the trim panel or component part 40 which removes the installation process for associates at general assembly line. This can eliminate having to attach extra fasteners to the casting or body part 14.

In certain embodiments, upon removal of the component part 40 from the casting or body part 14, the casting clip 36 will remain on the surface feature 16 of the casting or body part 14, which allows the component part 40 to be removed without damage to the casting clip 36. The casting clip 36 can retain its functionality over multiple uses. In certain embodiments, the casting clip 36 can be employed depending on if a high pull force extracts the part out of position. In certain embodiments, the casting clip 36 is employed when the mating feature on the polymer trim component (e.g., housing 38) is designed as a floating datum to absorb tolerances.

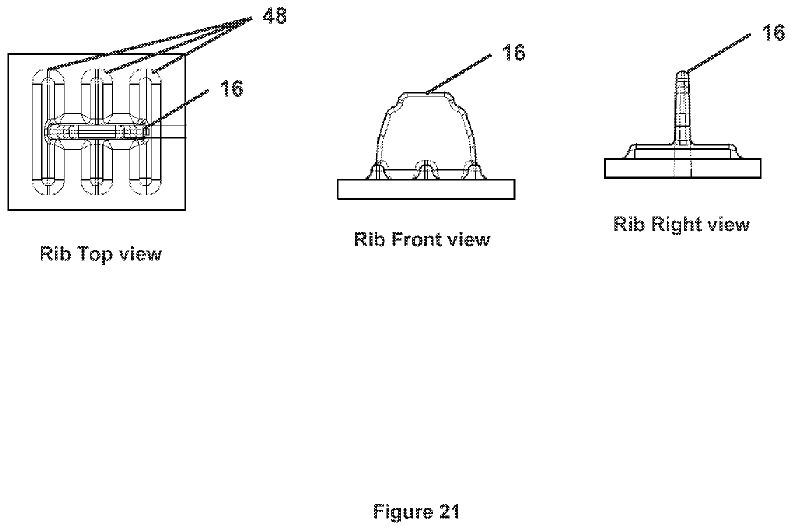

FIG. 21 includes views of a surface feature 16 configured to engage the casting clip 36, 46. The illustrated surface feature 16 comprises three legs 48. In certain embodiments, the casting clip 36 comprises a first engagement feature 42 configured to engage a component (e.g., housing 38) so as to secure the clip 36 to the component 38. In certain embodiments, the first engagement feature 42 comprises an outer shape of the casting clip 36. For example, the outer shape can have a generally triangular shape. In certain embodiments, the first engagement feature 42 comprises a lower groove 43. For example, the lower groove 43 can be configured to engage the component 38. In the illustrated embodiment, the casting clip 36 comprises two grooves 43.

In certain embodiments, the clip 36 further comprises a second engagement feature 44 configured to engage the surface feature 16 (e.g., rib) of the casting or body part 14 and remain engaged with the surface feature 16 when the component (e.g., housing 38 of component part 40) is disengaged from the first engagement feature 42 of the casting clip 36. In certain embodiments, the second engagement feature 44 comprises one or more spurs 41 configured to engage with the surface feature 16. In certain embodiments, the casting clip 36 comprises six spurs 41. In the illustrated embodiment, three spurs 41 extend in an inward direction from each side of the casting clip 36. Of course the casting clip 36 is not limited to having six spurs 41 and instead can have any number of spurs 41.

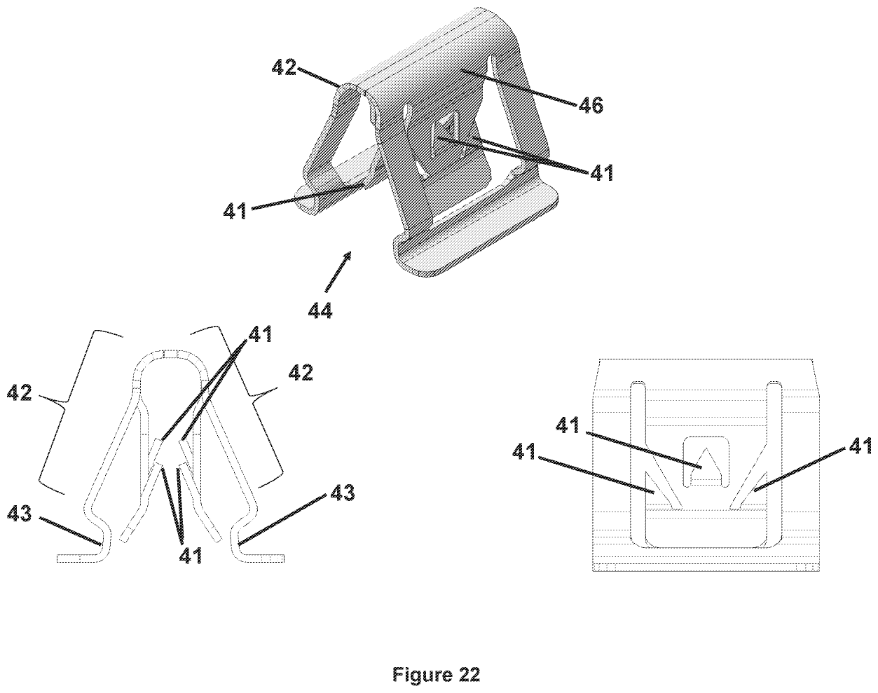

FIG. 22 includes views of a fourth embodiment of the casting clip 46 in the form of an inverted trim casting clip 46. In certain embodiments, the inverted trim casting clip 46 is pre-installed to a housing 38 (e.g., trim panel) and stays on the body part or casting 14 after initial trim installation. For example, in certain embodiments, the casting clip 46 is installed at the supplier level directly to the trim panel or component part 40 which removes the installation process for associates at general assembly line. This can eliminate having to attach extra fasteners to the casting or body part 14.

In certain embodiments, upon removal of the component part 40 from the casting or body part 14, the casting clip 46 will remain on the surface feature 16 of the casting or body part 14, which allows the component part 40 to be removed without damage to the casting clip 46. The casting clip 46 can retain its functionality over multiple uses. In certain embodiments, the casting clip 46 can be employed depending on if a high pull force extracts the part out of position. In certain embodiments, the casting clip 46 is employed when the mating feature on the polymer trim component (e.g., housing 38) is designed as a floating datum to absorb tolerances.

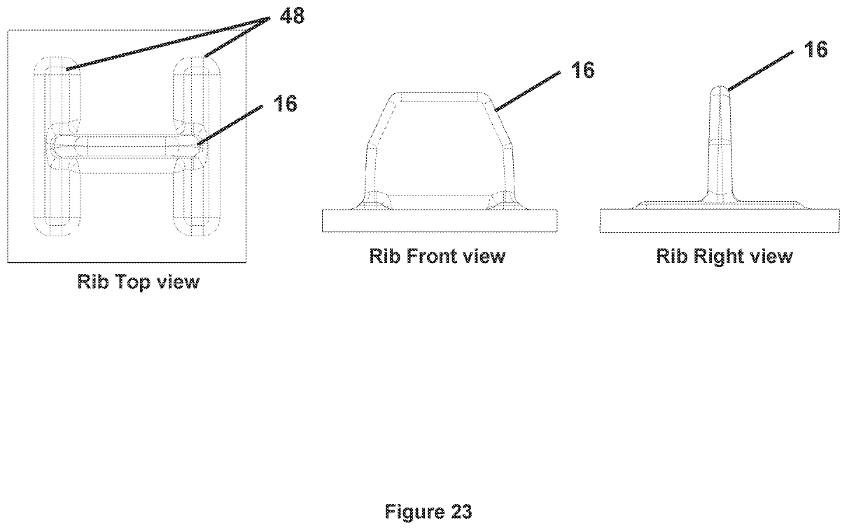

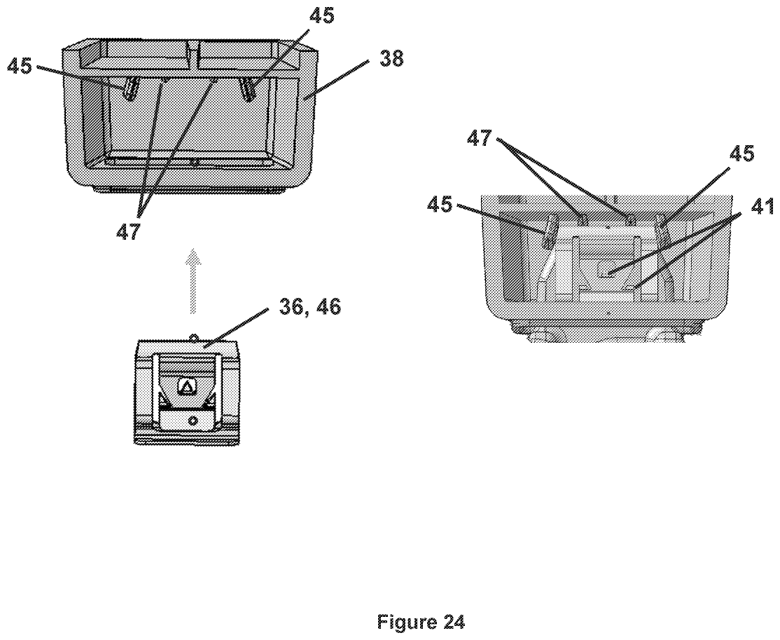

FIG. 23 includes views of a surface feature 16 configured to engage the casting clip 36, 46. The illustrated surface feature 16 comprises two legs 48. In certain embodiments, the casting clip 46 comprises a first engagement feature 42 configured to engage a component (e.g., housing 38) so as to secure the clip 46 to the component 38. In certain embodiments, the first engagement feature 42 comprises an outer shape of the casting clip 46. For example, the outer shape can have a generally triangular shape. In certain embodiments, the first engagement feature 42 comprises a lower groove 43. For example, the lower groove 43 can be configured to engage the component 38. In the illustrated embodiment, the casting clip 46 comprises two grooves 43. In certain embodiments, the first engagement feature 42 can be sized and shaped to provide a desired insertion force (e.g., see FIG. 24). In certain embodiments, the insertion force can be 20N. In certain embodiments, the max insertion force can be 60N.

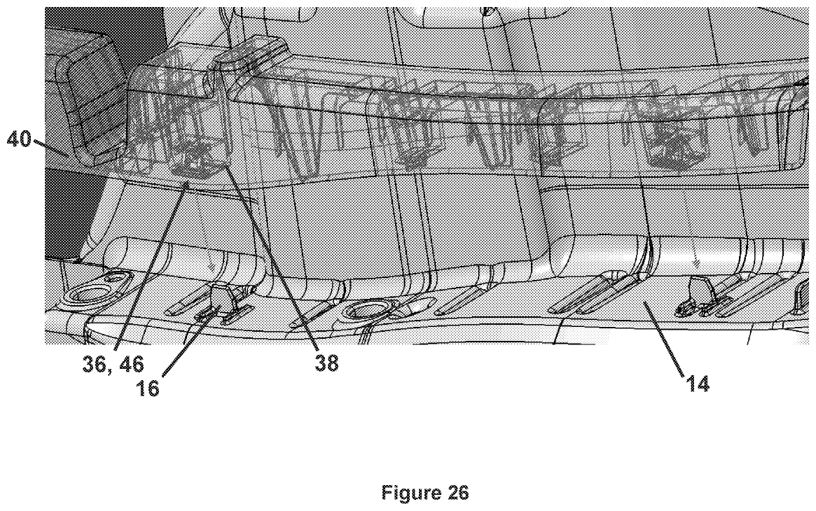

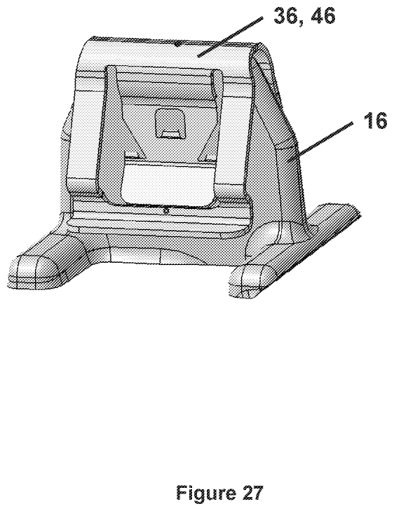

In certain embodiments, the clip 46 further comprises a second engagement feature 44 configured to engage the surface feature 16 (e.g., rib) of the casting or body part 14 and remain engaged with the surface feature 16 when the component (e.g., housing 38 of component part 40) is disengaged from the first engagement feature 42 of the casting clip 46. In certain embodiments, the second engagement feature 44 comprises one or more spurs 41 configured to engage with the surface feature 16. In certain embodiments, the casting clip 46 comprises six spurs 41. In the illustrated embodiment, three spurs 41 extend in an inward direction from each side of the casting clip 46. Of course the casting clip 46 is not limited to having six spurs 41 and instead can have any number of spurs 41. In certain embodiments, the one or more spurs 41 can be sized and shaped to provide a desired installation force and/or disassembly force (e.g., see FIGS. 26 and 27). In certain embodiments, the installation force can be 60N. In certain embodiments, the max installation force can be 75N. In certain embodiments, the disassembly force can be 110N. In certain embodiments, the max disassembly force can be 150N.

FIG. 24 shows a step 1 for inserting the casting clip 36, 46 into the housing 38 (e.g., housing 38 of component part 40). In certain embodiments, the casting clip 36, 46 is a metal component with spurs 41. In certain embodiments, a surface 45 of the housing 38 constrains movement of the casting clip 36, 46 in the z-direction. In certain embodiments, a surface 47 of the housing 38 constrains movement of the casting clip 36, 46 in the y-direction.

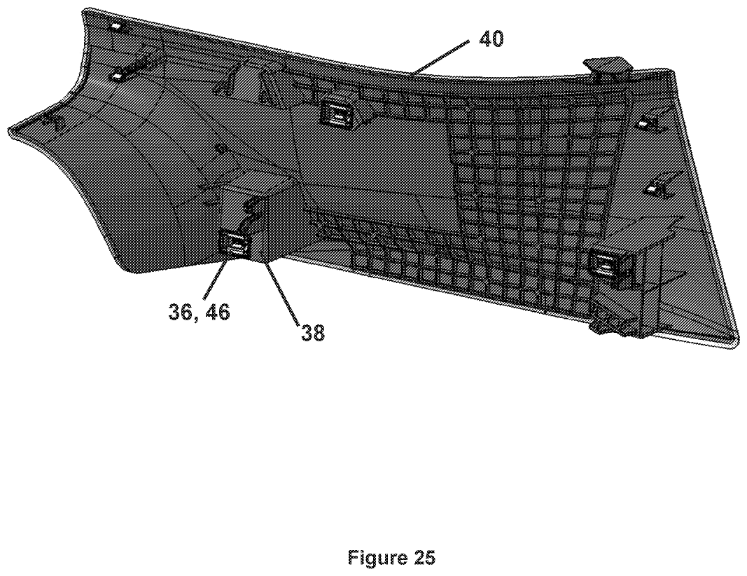

FIG. 25 shows a step 2 where the component part 40 has the clip 36, 46 installed in the housing 38 before subsequent assembly of the component part 40 to the casting or body part 14. FIG. 26 shows a step 3 where the housing 38 is being aligned above the surface feature 16 prior to lowering the component part 40 onto the casting 14. FIG. 27 shows a step 4 after the component part 40 has been removed from the casting 14 leaving the clip 36, 46 installed on the surface feature 16.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other. Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application.

1. A clip for securing a component to a body part, the body part comprising a die-cast material and a surface feature, the clip comprising:
a first engagement feature configured to engage the component so as to secure the clip to the component; and
a second engagement feature configured to engage the surface feature of the body part and remain engaged with the surface feature when the component is disengaged from the first engagement feature of the clip.

2. The clip of claim 1, wherein the component comprises a polymer.

3. The clip of claim 1, wherein the die-cast material is aluminum.

4. The clip of claim 1, wherein the body part is of a vehicle.

5. The clip of claim 1, wherein the clip is a cylinder type.

6. The clip of claim 5, wherein the clip comprises an insert, an overmold, and a base.

7. The clip of claim 6, wherein the insert comprises steel.

6. The clip of claim 6, wherein the overmold comprises polypropylene with 20% glass fiber (PP-GF20).

9. The clip of claim 6, wherein the base comprises polyoxymethylene (POM).

10. The clip of claim 6, wherein the insert, the overmold, and the base remain engaged with the surface feature when the component is disengaged from the first engagement feature.

11. The clip of claim 1, wherein the clip is a rib type clip.

12. The clip of claim 11, wherein the clip comprises a component clip, a holder, and a clamp.

13. The clip of claim 12, wherein the component clip comprises steel.

14. The clip of claim 12, wherein the holder comprises polyoxymethylene (POM).

15. The clip of claim 12, wherein the clamp comprises polyoxymethylene (POM).

16. The clip of claim 12, wherein the component clip remains engaged with the surface feature when the holder and the clamp are removed together as a subassembly.

17-21. (canceled)

22. A method of reusing a clip, the method comprising:
engaging the clip with a component part by applying an insertion force; and
engaging the component part and the clip as a subassembly to a surface feature with an installation force, wherein a disassembly force between the clip and the surface feature is greater than a disassembly force between the component part and the clip.

23. (canceled)

24. The method of claim 22, further comprising removing the component part from the surface feature while the clip stays engaged with the surface feature.

25. The method of claim 24, further comprising reattaching the component part to the clip while the clip is engaged to the surface feature.

26-27. (canceled)

28. A clip for securing a component to a body, the clip comprising:
a first engagement feature configured to engage the component so as to secure the clip to the component; and
a second engagement feature configured to engage the body, wherein a disassembly force between the clip and the component is less than a disassembly force between the clip and the body.

29-34. (canceled)
